(19) United States
(12) Patent Application Publication
(10) Pub. No.: US 2004/0044540 A1
(43) Pub. Date: Mar. 4, 2004

(54) Distributed environmental health & safety data collection and reporting

(76) Inventor: Susan Simons Hulett, Midland, MI (US)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/232,334

(22) Filed: Aug. 30, 2002

(51) Int. Cl. G06F 17/60

(52) U.S. Cl. 705/1; 705/2; 705/7

(57) ABSTRACT

A computer-implemented method for collecting into a comprehensive database all the data needed to generate certain identified reports, such as governmentally-required environmental and health and safety reports. At each facility within an organization, one or more processes for which data needs to be collected are defined. For each defined process, the detailed data needed to be collected is defined. The needed data corresponding to each defined process is then collected and stored into a comprehensive database on a remote server. The comprehensive database is advantageously utilized to generate compliance and regulatory reporting at various geographic levels and various organization levels. The comprehensive database also can be advantageously utilized to facilitate permit tracking, training tracking, health and safety reporting and recording, and waste monitoring and tracking. The invention also satisfies international standards set for environmental management systems, and will allow organization management to track environmental inputs, outputs and costs within an organization for a number of purposes, including assessments of the viability of process changes that might increase recycling or reduce pollution.

### BACKGROUND OF THE INVENTION

The present invention relates generally to systems and methods for collecting and providing comprehensive and consistent information across distributed working environments. Data from geographically-distributed entities in accordance with the present invention can be advantageously utilized to provide uniform environmental health and safety reporting and to provide management with a tool for analysis of processes across the distributed entities. The data reported can then be utilized either within a single organization, or provided externally to other organizations such as government agencies or the public.

Frequently, organizations are subject to vigorous analysis and governmentally mandated reporting requirements. Examples of governmentally-mandated reporting requirements include various environmental and health & safety reporting requirements. Organizations are required to keep stringent records on all chemicals and processes that may impact human health or the environment. These records are then required to be analyzed and otherwise utilized to produce the required reports, as well as to be retained as back up for later investigatory purposes.

Conventionally, organizations have struggled to efficiently meet both governmentally-mandated and internal reporting and analysis requirements. For example, environmental and health & safety reporting requirements can differ dramatically from facility to facility, even within or across facilities in larger organizations. Different facilities can have different reporting requirements because of the specific activities or processes that are conducted or utilized at different facilities. Different facilities may also have different reporting requirements simply because of their differing geographic locations. For example, facilities within a single organization may be located in different states and the states may have different reporting requirements. Additionally, organizations impose their own internal reporting requirements. These internally-imposed reporting requirements may be substantially different than governmentally-imposed reporting requirements because they may utilize and incorporate additional data of interest to the organization, but not required to be reported to governmental entities, such as internal financial or control data.

Frequently, these differences in reporting requirements cause organizations to use multiple, independent systems to meet its various reporting requirements. That is, an organization may use one system to meet its environmental reporting requirements, a second system to meet its health & safety reporting requirements, and a third system to meet its financial reporting requirements. Using multiple, independent systems to capture data for individual reports, which in turn are submitted to various end-users, frequently requires the same data to be input multiple times. Inputting data multiple times is inefficient and leads to inconsistencies and errors within individual facilities, as well as over- or under-stated differences in reported results between facilities within the same organization.

In the absence of the present invention, inconsistent counting and input can occur, as different systems utilized for each reporting function may report the same data differently to meet distinct reporting obligations. To date, there has not been a system flexible enough to be utilized across a number of different types of organizations, at different locations, utilizing numerous different processes, which can be collected into a comprehensive database at a detailed enough level to be used for the large number of reporting and analysis functions required of organizations by regulators and management alike. Existing systems also result in significant duplication of effort, as similar data may be required to be entered more than once into multiple systems to accomplish the same result as the single system utilized by the invention.

Accordingly, there is a substantial need in industry for a comprehensive report-oriented database which would allow for the uniform, accurate and comprehensive analysis of detailed environmental and health & safety data in order to facilitate pollution prevention, environmental analysis, and other informational purposes which would benefit from such a database. There is also a need in industry for a comprehensive system to facilitate environmental, health & safety, or related reporting, as well as financial and chemical tracking.

### SUMMARY OF THE INVENTION

The present invention addresses the problems noted above by providing novel systems and methods for collecting data associated with specific business production processes, in fact any commercial process, storing the process data into a comprehensive database, and producing environmental, health safety or other related reporting and analysis capability. The present invention facilitates collection of detailed data relating to each process at any facility within an organization, regardless of its geographic location and the fact that each facility might utilize substantially different production processes. The process data is stored in a comprehensive database, which facilitates the complex analysis of the data and facilitates the generation of reports of various levels of complexity, based on the data.

In a first aspect, the present invention is a computer-implemented method for collecting detailed production process data into a comprehensive database. Server-based algorithms can be utilized to generate a large number and variety of reports from the comprehensive database. The reports generated by the invention include governmentally-required environmental and health & safety reports, as well as reports that can be utilized by internal management to help an organization assess all environmental and health & safety aspects of their production processes in accord with international standards governing computerized management systems. At each facility within an organization, the first step is to identify and define one or more production or commercial processes for which data needs to be collected for reporting purposes. For each defined process, the appropriate data needed to be collected is then defined. This necessary data, corresponding to each defined production or commercial process, is then collected and stored into a comprehensive database.

The comprehensive database can be advantageously utilized, by server-based algorithms and software systems located at a central location, to generate environmental compliance and regulatory reporting at various geographic levels and various organization levels. By providing consistent methods of collecting detailed production process data through the use of a uniform user interface, systems of the present invention enable an organization's environmental, health & safety, or related reporting to achieve a much higher degree of accuracy and consistency. Further, by providing a single, password-protected comprehensive database, the present invention can provide significantly improved security.

In a preferred embodiment, the present invention can be advantageously utilized to collect environmentally-related data from geographically-distributed entities and to provide uniform environmentally-related reporting and analysis capability across the distributed entities. In a second preferred embodiment, the invention can be advantageously utilized to facilitate regulatory permit tracking for an organization. In a third preferred embodiment, the present invention can be advantageously utilized to facilitate tracking individual employee training within an organization, as may be required by governmental agencies or organizations themselves. In a fourth preferred embodiment, the present invention can be advantageously utilized to facilitate all Occupational Health and Safety Administration (“OSHA”) reporting and recording and other health & safety reporting and recording required by an organization or by governmental agencies. In a fifth preferred embodiment, the present invention can be advantageously utilized to facilitate the monitoring and tracking of waste in accord with applicable laws. In a sixth preferred embodiment, the invention provides flexible reporting and monitoring capabilities to an organization's management in accord with environmental management system requirements set forth by the International Standards Organization (“ISO”), standard ISO 14000.

### BRIEF DESCRIPTION OF THE DRAWINGS

The present invention can be understood more completely by reading the following Detailed Description of exemplary embodiment, in conjunction with the accompanying Drawings, in which:

FIG. 1 shows a flow chart describing a method for data collection according to a preferred embodiment of the present invention;

FIG. 2 shows a flow chart describing a method for analysis reporting according to a preferred embodiment of the present invention;

FIG. 3 shows a flow chart describing a method for data review according to a preferred embodiment of the present invention;

FIG. 4 shows a flow chart describing a method for final reporting according to a preferred embodiment of the present invention.

### DETAILED DESCRIPTION OF THE INVENTION

The present invention provides novel systems and methods for collecting data associated with specific business production processes, in fact any commercial process, storing the process data into a comprehensive database, and producing reporting and analysis related to the data in the comprehensive database. Thus, in one aspect, the present invention comprises systems and computer-implemented methods for collecting detailed production process data into a comprehensive database. By comprehensive it is meant that the database contains all the data collected for an entire organization for the purpose of generating both internal and external reports. This is true even if the organization comprises multiple, geographically-distributed facilities.

Although copies of the data may exist at one or more facilities in the organization, the present system is designed so that all of the needed data is collected into a single, server-based comprehensive database. The comprehensive database can be implemented using tools and techniques known in the art of information systems technology. Server-based algorithms can be utilized to generate a large number and variety of reports related to the data in the comprehensive database.

The systems and methods of the present invention are preferably implemented by an interactive computer software system within a computer-readable medium such as a hard disk drive, an optical medium such as a compact disk, or the like. Systems of the present invention comprise a comprehensive database that can reside on a remote server. By remote it is meant that the comprehensive database is not required to be located at any of an organization's facilities. The comprehensive database is preferably accessed by individual facilities, and is available to a plurality of distributed users utilizing microcomputers located at or near individual facilities within an organization and connected to a remote server via an encrypted connection. A copy of the portion of the comprehensive database relating to a particular facility is generally kept locally within that facility, while the master copy of the comprehensive database will be kept on the remote server. For the purposes of the present specification, the term system will be used to mean the hardware and software that implement an embodiment of the present invention.

The systems contained in the invention serve a number of functions, each of which can be advantageously utilized by various organizations. These functions include environmental reporting, health and safety reporting, permit tracking, training tracking, the monitoring and tracking of waste, and the generation of management reports in accord with ISO 14000.

The present invention has the capability to be advantageously utilized in organizations comprising geographically-distributed facilities. For purposes of the present invention, a facility means a geographic site within an organization (e.g., a corporation), wherein each facility comprises one or more processes. A process includes any activity whereby any material is stored, produced, used, manufactured, wasted, emitted, or transferred. Each process has associated with it data that is needed to generate one or more required reports.

According to the present invention, each facility has data associated with it that is specific to that facility and is stored in the comprehensive database. This data generally includes the facility identification, which uniquely identifies the facility. The facility identification can take multiple forms such as names or codes. Typically, each facility will have one or more unique codes associated with it that are assigned to the facility by an external organization. For example, for environmental reporting purposes, each facility is assigned a unique code by the Environmental Protection Agency (“EPA”). Other facility-related information utilized in accordance with the present invention may include, for example, address, a map of the site, phone numbers, fax numbers, etc. Other data that is associated with each facility include, for example, Source Reduction Codes mandated by the U.S. Government.

In accordance with the present invention, each facility has associated with it one or more processes. Each process will have data associated with it. Collecting this process data is needed in order to produce the wide variety of reports required to be produced from the comprehensive database. The present invention is unique in that it collects and stores, in the comprehensive database, information to a high degree of detail, so as to allow a number of internal and external reports to be generated from a single comprehensive database. Historically, proprietary systems have collected only the information needed for specific reporting forms. By collecting detailed information about individual production processes into a single comprehensive database, new reporting requirements can often be addressed with existing information contained within the comprehensive database. Similarly, detailed process information allows individuals maximum flexibility in generating internal management reports consistent with ISO 14000.

Typically, utilization of the present invention involves at least one individual at each facility, herein referred to as a facility administrator, who is responsible for inputting all facility-specific data as well as identifying and defining all processes located at the facility. Upon initial use of the present invention at an existing facility or whenever a new facility is added to an organization, the facility administrator performs a facility definition process by initially entering or inputting all the facility-specific data into a system embodying the present invention. Once the facility has been defined, the corresponding data should not have to be reentered, unless the data has changed (e.g, changed phone number) and needs to be updated.

Once a facility has been defined, a facility administrator will further define each of the specific production processes that are utilized at that facility. Defining a facility process in accordance with the present invention includes giving the process an identification code and creating and maintaining facility specific data (such as off-site codes or stream names as required regulators). The user interface embodied in the present invention simplifies the identification of specific facility and process information through the use of menus and lists which allows the facility administrator to select and identify such information in a consistent and uniform manner.

Typically, the facility administrator will assign an individual, herein referred to as a Process Specialist, to one or more production processes within a facility. The Process Specialist is provided with a system user ID and password that allows the Process Specialist sufficient access to enter the required data related to the process to which the Process Specialist has been assigned. The Process Specialist is familiar with his or her defined process and is typically responsible for inputting all the required data for the assigned process.

When a Process Specialist accesses a system of the present invention (typically by entering the assigned user ID and password), the system displays input screens that the Process Specialist interacts with to enter the required data. The Process Specialist is also responsible for creating a block flow diagram for the process, identifying all materials within the process, including the identification of all materials input to the process, identifying all materials created from the process, and identifying all materials output from the process (i.e., process waste). Once the required data is entered on a computer located at the facility, it is copied to the comprehensive database. Systems of the present invention record and keep track of all data entered for each process.

Systems of the present invention also keep a record of all geographic levels and all organizational levels to which a process belongs and at which level a report may need to be generated. Each process will typically be associated with a city, county, state or province, and country. For example, if a state governmental agency requires a report incorporating all process data associated with activities within that state, systems of the present invention can readily produce such a report.

This unique flexibility goes beyond the ability to generate geographically specific reports. Each process and its related data is associated in the comprehensive database with all the organizational levels within an organization to which the process belongs (for example, a specific building, facility, business, division, and corporation). In this manner, systems of the present invention can readily generate a report at a give organizational level (for example, a facility) that incorporates the data from all processes within that level. Thus, systems according to the present invention can utilize the data collected in the comprehensive database to generate reports based on data associated with a single process, generate reports based on data collected from all processes at a single facility, generate reports based on data collected from all processes at all facilities within a geographic region (such as a city, county, state, or country), or generate reports based on data collected from all processes at all facilities within the entire organization (such as an international corporation, for example).

### DRAWINGS

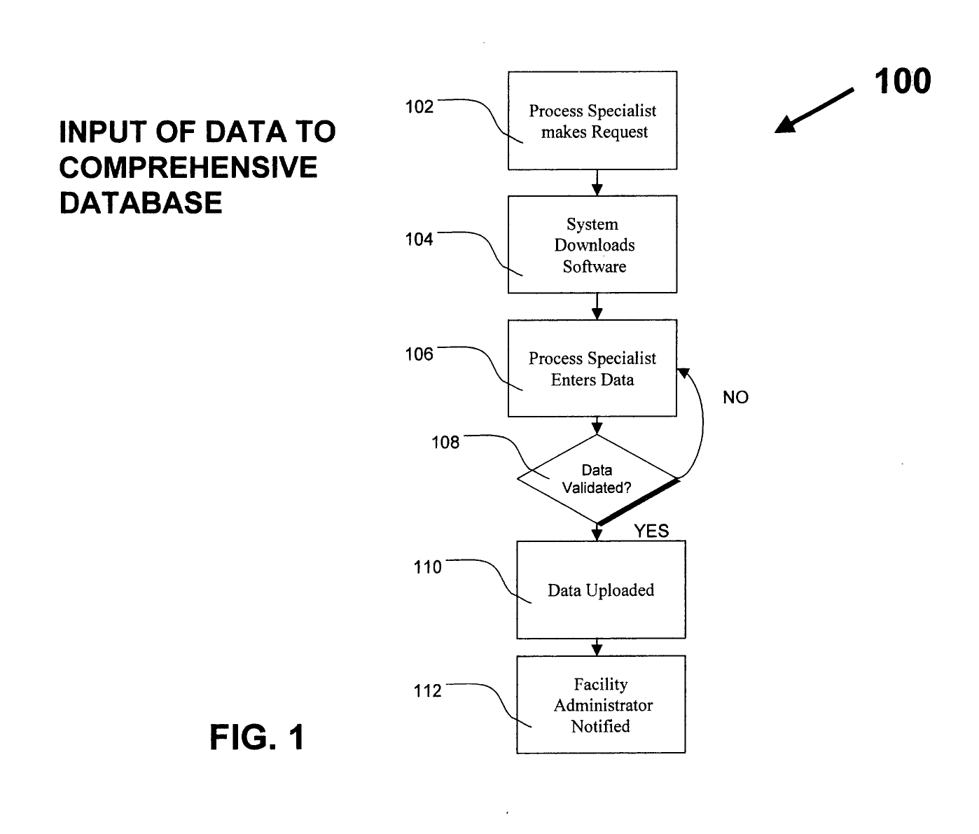

Additional understanding of the present invention and its advantages can be obtained by referring to the Drawings, wherein preferred embodiments of the present invention are described. In FIG. 1, there is shown a flow chart describing a unique method 100 for production process data collection and entry in a preferred embodiment of the present invention. Such data collection and entry into the system embodied by the invention is required as a predicate to virtually every reporting function of the invention. In step 102, a Process Specialist makes a request to the remote server from his or her local computer to enter process data. This request can typically be accomplished by logging into the system using a user ID and password. Once any security checks have been done, validating the Process Specialist, the request to enter data is completed.

Once the Process Specialist completes the request to enter data, the system downloads the most recent updated software 104, including the user interface, to the Process Specialist's computer. The data to be entered is related to a specific process and typically includes specific chemical data needed for formulation of environmental reporting. Typically, the system will also retrieve from the comprehensive database and display the current process data. By updating the software and user interface with each use, a client organization can be assured that the most up to date chemical specific data relating to a particular process is available, and that all data required to satisfy the most current reporting requirements is identified and input.

The Process Specialist then interacts with the downloaded software to add to or modify the process data 106. Once the data relating to a particular production process has been entered, the data is checked for validity 108. For example, if the process specialist enters an incorrect numerical chemical code, the system embodied in the invention will identify the code as not conforming with prior entries associated with a known process. If data is not validated, then the system indicates such to the Process Specialist and the Process Specialist makes any corrections necessary to allow submission of the process data 106. Another common reason for invalidating the data is that not all required data is entered. In that instance, the Process Specialist is notified and requested to enter the missing data.

Once the data is validated, it is uploaded 110 to be stored in the comprehensive database. The detailed process data can be uploaded in any format (XML, for example) understood by those of ordinary skill in the art of information technologies. This allows for increased flexibility with respect to the inventions use with existing or legacy systems already located at the client organization. Finally, once the uploaded process data has been received the system notifies the corresponding Facility Administrator that the data has been received 112.

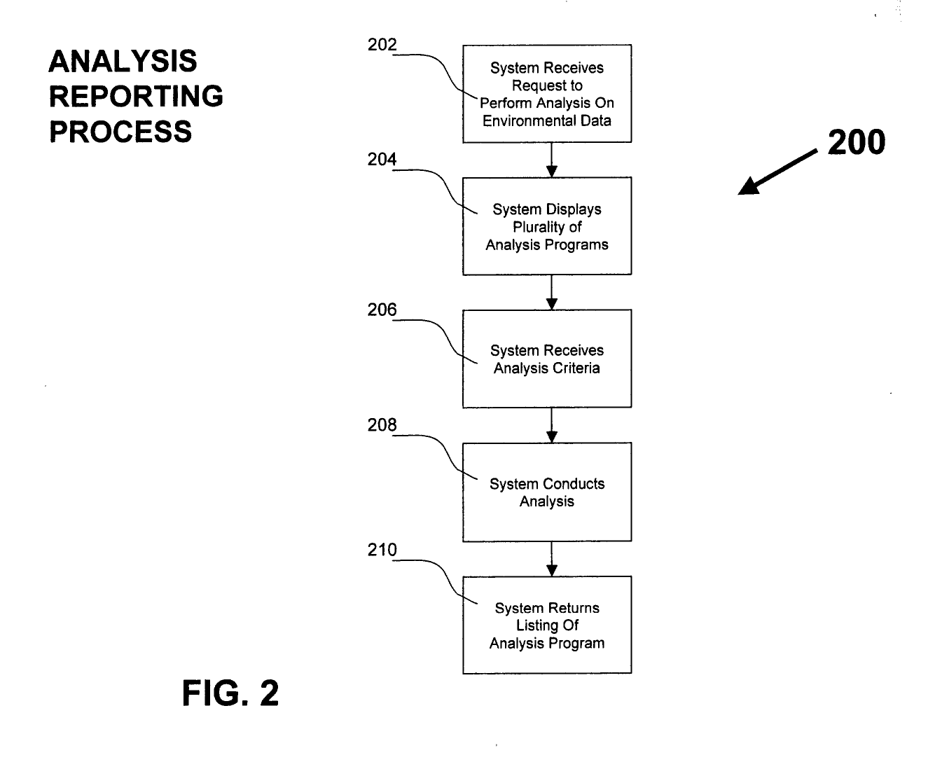

In FIG. 2, there is disclosed a flow chart describing one embodiment of a method 200 for the analysis of database information which facilitates internal reporting. Embodiments of the present invention can be advantageously utilized to perform valuable internal analysis functions on the stored process data. A request is made to the system to perform an internal analysis on detailed process data, step 202. The system displays a plurality of options to create a custom analysis, as dictated by the organizational user, step 204. The system receives the analysis criteria, step 206, and conducts the analysis, step 208, thereby producing invaluable information pertaining to the detailed process data associated with particular production processes. Substantial cost savings and pollution prevention could possibly be obtained through the evaluation of the analysis.

In step 210, internal reports generated by the system can be extremely beneficial to an organization. For example, pollution prevention programs and goals can be set within the organization on a geographical basis. Additional detailed reports can be requested by the user to identify specific information pertaining to a particular geographical facility. The system also allows for environmental goal setting of facility and corporate levels, where analysis of this type can be most beneficial.

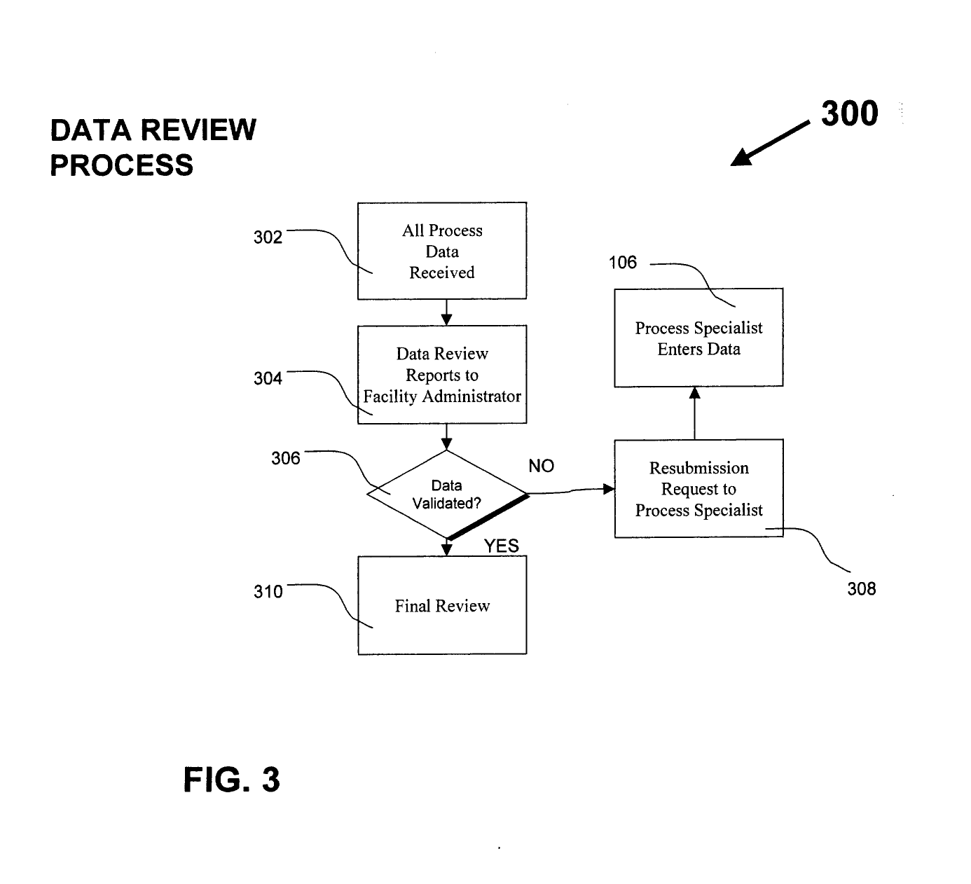

FIG. 3 shows a flow chart describing the data review process 300, according to a preferred embodiment of the present invention. Once all the environmental data from all processes has been entered by all the Process Specialists, validated, and received 302 by the system, Facility Administrators can request review reports from the system. The review reports are sent to the requesting Facility Administrator 304. The Facility Administrator can analyze the review reports and either approve the data or reject the data 306.

If the data for a particular process is rejected by the Facility Administrator in step 306, the Facility Administrator requests an electronic notification be sent from the system to the corresponding Process Specialist regarding the form and nature of the rejection, including specific information as to why the process data was rejected. The notification will also include requests for correction and resubmission of the process data, step 308. After reviewing the rejection notification and resubmission request, the Process Specialist can make the necessary changes to correct the process data and resubmit to the computer system 106.

If the resubmitted process data is subsequently approved by the Facility Administrator in step 306, the Facility Administrator can request final reports from the system. In the final step, 310, the final review is completed. After the Facility Administrator has completed the final review, electronic notification is sent to an organizational administrator, indicating the final review is complete.

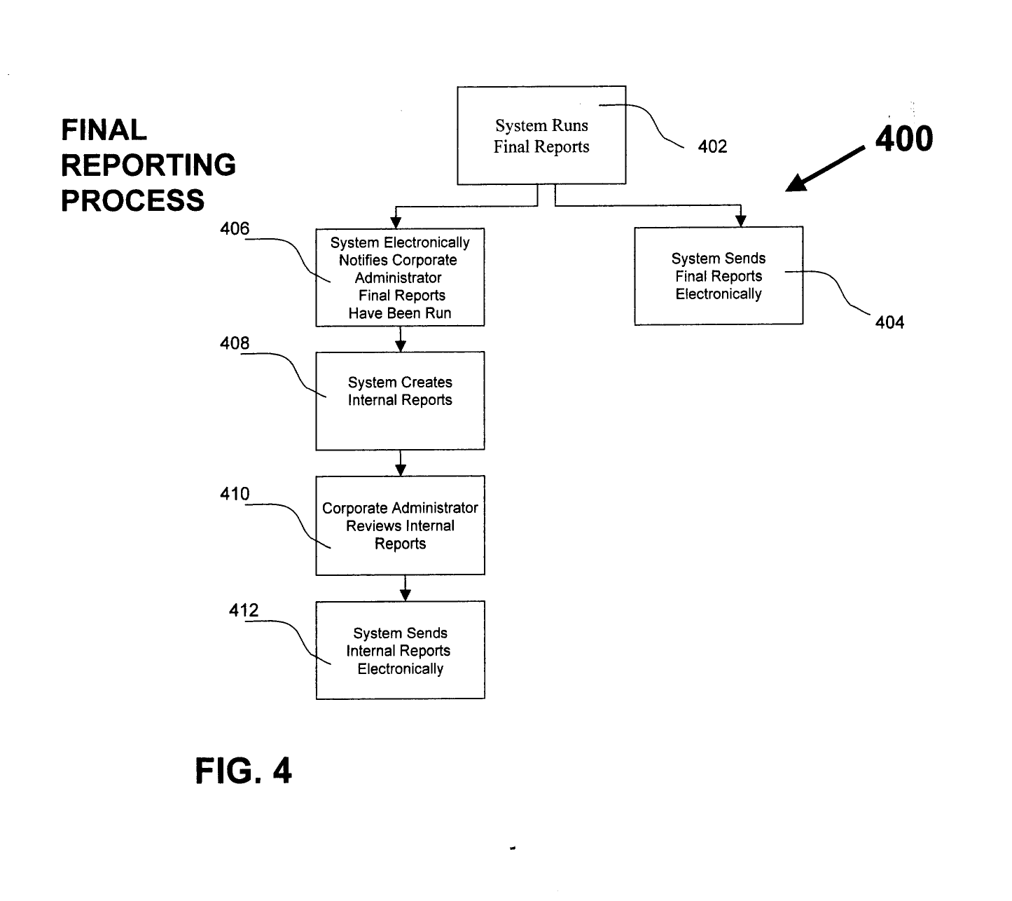

Referring now to FIG. 4, there is shown a flow chart describing a method of reporting 400 according to a preferred embodiment of the present invention. In step 402, the Facility Administrator requests final reports from the system. It is important to note, that because systems of the present invention comprise a comprehensive database containing all process data, a large number of widely disparate reporting requirements (for example, environmental reporting requirements) can be met using the detailed data in the single comprehensive database. In a preferred embodiment of the present invention, these reporting requirements cover all pertinent environmental and health & safety regulatory compliance reporting for any geographical entity, as well as internal environmental or related reporting for any geographical entity.

With respect to external or government-mandated reports, the system has the capability of generating final reports as either electronic or hard copy paper reports. After creation of the reports in final draft form, the Facility Administrator can request the system to electronically send (via electronic mail, for example) the final draft reports to any geographically diverse governmental entity, step 404.

With respect to internal reports, systems of the present invention have the capability and flexibility to conform with many existing organizational reporting structures. In step 406, the system electronically notifies a designated organization administrator that a final draft of a particular internal report has been run and finalized for his or her review. The organization administrator can then request all internal or related reporting to be done by the computer system, step 408. The organization administrator can then review the internal reports, step 410, and requests the computer system to send the internal reports to any geographical entity within the organization, step 412.

By providing a uniform process for providing organization-wide environmental, health & safety, or other related reporting and analysis capabilities, the system of the present invention, substantially solves the problems with inconsistency inherent in conventional reporting systems. The data collection methods of the present invention, including its user interface and menu driven nature, require consistency of data across and within facilities.

In addition to consistency, the above-described invention further provides for a uniform system for recording all production process data that is subsequently capable of internal analysis, which can result in substantial cost savings. For example, the implementation of a pollution prevention program based on system output can substantially reduce waste streams and related disposal and handling costs.

Further, because of the computer-based nature of the inventive system, users can utilize the calendaring functions of the system to provide electronic notifications of both internal and external (regulatory) deadlines. This greatly reduces missed deadlines and increases efficiency in the completion of time critical reporting. Once reports have been generated, the structure of the present invention allows simplified verification of reported figures by either internal or external auditors.

### EMBODIMENTS

In one embodiment, the present invention provides a system that facilitates environmental compliance and regulatory reporting (“environmental reporting”) at various geographical levels and various organizational levels. The comprehensive database of the present invention can facilitate the tracking of all data needed for an organization's environmental compliance and regulatory reporting. The present invention is also designed to facilitate the creation of a comprehensive database by facilitating the collection of needed environmentally-related data and regulatory data from a plurality of geographically-distributed facilities. Thus, the present invention can be advantageously utilized to collect needed data from a plurality of geographically-distributed facilities, store the collected data into a comprehensive database, and generate environmental compliance and regulatory reporting from that data in the comprehensive database.

In a second preferred embodiment, the present invention is advantageously utilized to facilitate permit tracking in an organization. Typically, each facility in an organization is required to obtain at least one, and usually multiple, permits in order to perform the production processes that exist at the facility. The data associated with each permit is stored in the comprehensive database in a manner that directly associates it with any process that requires the permit. The system is also capable of tracking and collecting data relating to a permit that may not be associated with any particular production process.

Permit data collected includes, for example, the date the permit was obtained and the date the permit expires. The permit data can be stored in the comprehensive database in any format known to one of ordinary skill in the art of information systems technology or database technology. In this embodiment, a user can look up a permit in the comprehensive database and retrieve a list of processes that require that permit. Alternately, a user can look up a process in the comprehensive database and retrieve a list of permits required for that process. Additionally, preferred embodiments of the present invention can automatically send a user an electronic reminder notice (via electronic mail, for example) when key permit requirements are approaching. For example, a user might be notified that a permit is about to expire so the user has sufficient time to determine whether the permit needs to be renewed and has time to renew the permit.

In a third preferred embodiment, the present invention can be advantageously utilized to facilitate training tracking for an organization. As is generally known in industry, training tracking involves keeping track of the training that may be required of individuals (employees or contractors, for example) by either regulatory authorities or the organization itself. The system would keep track both of the required training, including generation of notices to individuals, as well as the training actually completed by those individuals.

According to this preferred embodiment, the training tracking data is stored in the comprehensive database such that a user of the present invention can also readily obtain from the database a list of individuals having a particular form of training, as well as a list of all training received by a particular individual. In another preferred embodiment, the training tracking data is entered into the comprehensive database at the process level. That is, each process has associated with it in the comprehensive database any training that is required of those individuals who work with the specific production process (for example, any training to operate equipment used in the process).

In a fourth preferred embodiment, the present invention can be advantageously utilized to facilitate all health & safety reporting and recording required by an organization, including OSHA requirements. Health & safety reporting and recording requirements are well known in industry and involve the reporting to government entities of certain health-related incidents that occur in the workplace. In this preferred embodiment, all health & safety data for a given organization is entered into the comprehensive database. In another preferred embodiment, all health & safety data is entered at the process level. That is, any reportable health & safety incident that occurs and is related to a particular process is entered into the comprehensive database as associated with the process. In this manner, a user of the present invention can query any process for an organization and retrieve a list of health & safety-related incidents and the information associated with any incident on the list.

In a fifth preferred embodiment, the present invention can be advantageously utilized to facilitate the monitoring and tracking of waste associated with a particular production process. Waste may be defined as either loss of raw material or byproduct generated by the process itself. In this embodiment, the cost of the raw material purchased for a process is associated with the process. Thus, the costs associated with any wasted raw material can be recorded and reported. Similarly, systems according to the present invention can track the cost of off-Facility waste transportation and disposal. In this manner, all costs attendant to the wastes produced in association with a particular process can be readily compared to the cost of wastes associated with a similar process. Additionally, the cost of waste at one facility can be compared to the cost of waste at a different facility. These comparisons are useful tools for management of an organization.

Finally, in a sixth preferred embodiment, the present invention also satisfies international requirements and standards for environmental management systems, as set forth by the International Standards Organization in its ISO 14000. Environmental management systems, as defined in ISO 14000, provide a means by which management of an organization can track environmental inputs, outputs and cost costs within an organization for a number of purposes, including assessments of the viability of process changes that might increase recycling or reduce pollution. The comprehensive database, which is an integral part of the present invention, can be advantageously utilized to efficiently produce such management reports in strict accord with ISO 14000.

While the foregoing description includes many details and specificities, it is to be understood that these have been included for purposes of explanation only, and are not to be interpreted as limitations of the present invention. The varying nature of governmental reporting requirements alone, to say nothing of the varying internal reporting needs of the many types of organizations, will require frequent modifications to the embodiments described above. Nevertheless, such modifications can be readily made without departing from the spirit and scope of the invention, as is intended to be encompassed by the following claims and their legal equivalents.

What is claimed is:

1. A computer-implemented method for collecting into a comprehensive database data needed for generating one or more reports, comprising the steps of:
a. defining, for each facility in a plurality of facilities, one or more processes from which the data is to be collected;
b. defining for each process the data to be collected;
c. collecting the data corresponding to each defined process;
d. storing the data collected for each defined process into the comprehensive database.

2. The method of claim 1, wherein the data collected includes data necessary to be collected for generating environmental reports.

3. The method of claim 2, wherein the data collected includes data necessary to produce reports including SARA311, SARA312, SARA313, and RCRA reports.

4. The method of claim 1, wherein the data collected includes data necessary to be collected for generating health and safety reports.

5. The method of claim 4, wherein the health and safety reports include OSHA reports.

6. The method of claim 1, wherein the data collected includes permit data.

7. The method of claim 1, wherein the data collected includes training tracking data.

8. The method of claim 1, wherein the data includes the tracking and costing of waste associated with each process.

9. A computer-implemented method for generating one or more reports from data in a comprehensive database, comprising the steps of:
a. defining, for each facility in a plurality of facilities, one or more processes from which the data is to be collected;
b. defining for each process the data to be collected;
c. collecting the data corresponding to each defined process;
d. storing the data collected for each defined process into the comprehensive database;
e. generating reports from the data stored in the comprehensive database.

10. The method of claim 9, wherein the data collected includes data necessary to be collected for generating environmental reports.

11. The method of claim 9, wherein the data collected includes data necessary to be collected for generating health and safety reports.

12. The method of claim 9, wherein the generating reports step generates environmental reports.

13. The method of claim 12, wherein the environmental reports generated include SARA311, SARA312, SARA313, and RCRA reports.

14. The method of claim 9, wherein the generating reports step generates health and safety reports.

15. The method of claim 14, wherein the health and safety reports include OSHA reports.

16. A database containing all the data collected for an entire organization for the purpose of generating reports, wherein the data collected includes process data collected from a plurality of processes at a plurality of facilities within the organization.

17. The database of claim 16, wherein the database contains environmental data.

18. The database of claim 16, wherein the database contains permit data.

19. The database of claim 16, wherein the database contains training tracking data.

20. The database of claim 16, wherein the database contains health and safety data.

21. The database of claim 16, wherein the process data includes the tracking and costing of waste associated with the process.

22. The database of claim 16, wherein the process data includes data sufficient to allow internal reporting consistent with international standards established for environmental management systems.
